(19) United States
(12) Patent Application Publication
(10) Pub. No.: US 2019/0286686 A1
(43) Pub. Date: Sep. 19, 2019

(54) Approximate evaluation method for reliability of large-scale multi-state series-parallel system

(71) Applicant: Yi Ding, Hangzhou, Zhejiang (CN)

(72) Inventor: Yi Ding, Hangzhou, Zhejiang (CN)

(21) Appl. No.: 16/313,146

(22) PCT Filed: Mar. 17, 2018
(86) PCT No.: PCT/CN2018/079377

§ 371 Date: Dec. 25, 2018

(51) Int. Cl. G06F 17/18; G06F 17/50; G06F 17/17

(52) U.S. Cl. CPC G06F 17/18; G06F 17/17; G06F 17/5009

(57) ABSTRACT

An approximate evaluation method for reliability of a large-scale multi-state series-parallel system is provided, wherein for a multi-state series-parallel system, a connection structure between a parent node and all child nodes thereof is divided into four categories which are treated differently; according to the four categories, the probability distribution of the parent node of each level of a complete tree structure is calculated in turn from end leaf nodes; finally, probability distribution of a root parent node of the whole multi-state series-parallel system is obtained, thereby obtaining the reliability of the multi-state series-parallel system. The present invention realizes approximate evaluation of the reliability of the large-scale multi-state series-parallel system, and realizes a balance between calculation accuracy and calculation efficiency, so as to improve computational complexity from exponential complexity of originally accurate calculation to a quadratic term, thereby greatly improving a calculation speed.

### CROSS REFERENCE OF RELATED APPLICATION

This is a U.S. National Stage under 35 U.S.C. 371 of the International Application PCT/CN2018/079377, filed Mar. 17, 2018, which claims priority under 35 U.S.C. 119(a-d) to CN 201810008453.7, filed Jan. 4, 2018.

### BACKGROUND OF THE PRESENT INVENTION

### Field of Invention

The present invention relates to reliability evaluation of multi-state series-parallel systems, and more particularly to an approximate evaluation method for reliability of a large-scale multi-state series-parallel system.

### Description of Related Arts

As a generalization of the binary state system, the multi-state system can describe the complex system in practical engineering in a more detail way. The series-parallel structure is one of the most common system structures, and is widely used in power systems, transmission systems, etc. At the same time, the installation problems and standby design problems based on series-parallel systems are popular research directions. Therefore, the reliability evaluation of multi-state series-parallel systems plays an important role in practical engineering.

With the development of the industrial level, the scale of the engineering system has gradually expanded. In large-scale multi-state series-parallel systems, the number of components and states of the system is very large. For example, with the rapid development of new energy sources, more and more wind turbines are connected to the power grid, and the reliability of a wind turbine requires dozens or even hundreds of states to be finely characterized. Therefore, large-scale multi-state series-parallel systems have extremely high demands on the computational efficiency of reliability.

Conventional multi-state series-parallel system evaluation methods, such as UGF method, recursive method, Monte Carlo simulation method, etc., are limited in computational efficiency when calculating large-scale systems. Since accurately computing the system reliability often requires exponential computational complexity, this computational burden is unacceptable for large-scale systems. Therefore, it is imperative to find an approximate evaluation method that is efficient and accurate for the reliability evaluation of large-scale multi-state series-parallel systems.

### SUMMARY OF THE PRESENT INVENTION

An object of the present invention is to overcome shortcomings of conventional large-scale system reliability evaluation methods, and to provide an approximation calculation method for reliability of a large-scale multi-state series-parallel system, wherein continuization discretization approximation is adopted to quickly and efficiently approximate the reliability of the large-scale multi-state series-parallel system, and provide a relatively accurate, error-acceptable approximation.

The large scale of the present invention refers to a series-parallel system with no less than one hundred system components. When the component reach or exceed such magnitude, the conventional system reliability accurate evaluation method will be very time-consuming and computationally inefficient.

Accordingly, in order to accomplish the above objects, the present invention provides:

an approximate evaluation method for reliability of a large-scale multi-state series-parallel system, wherein:

for a multi-state series-parallel system which is converted to a tree structure, a connection structure between a parent node and all child nodes thereof is divided into four categories: first, a parallel subsystem formed only by connecting multiple components to the same parent node in parallel as the child nodes; second, a parallel subsystem formed by connecting multiple components and multiple nodes whose subordinate connections are all in series to the same parent node in parallel as the child nodes; third, a series subsystem formed by connecting multiple components to the same parent node in series, and fourth, a series subsystem formed by connecting multiple components and multiple nodes whose subordinate connections are all in parallel to the same parent node in series as the child nodes.

If subordinate connections of the parent node are in series, the subordinate connections of the child nodes subordinate to the parent node cannot be in series, because components subordinate to the child nodes whose subordinate connections are all in series may be equivalently regarded as subordinate components of a parent node whose subordinate connections are all in series. Similarly, if subordinate connections of the parent node are in parallel, the subordinate connections of the child nodes subordinate to the parent node cannot be in parallel, because components subordinate to the child nodes whose subordinate connections are all in parallel may be equivalently regarded as subordinate components of a parent node whose subordinate connections are all in parallel.

For the four categories, the approximate evaluation method comprises steps of:

A) for the parallel subsystem formed only by connecting the multiple components to the same parent node in parallel as the child nodes as shown in FIG. 2, calculating and comparing a continuization value, and then calculating with Gaussian approximation or UGF (Universal Generating Function) to obtain a probability distribution of the parent node;

B) for the parallel subsystem formed by connecting the multiple components and the multiple nodes whose subordinate connections are all in series to the same parent node in parallel as the child nodes as shown in FIG. 4, calculating and comparing the continuization value, and then calculating with the Gaussian approximation or the UGF to obtain the probability distribution of the parent node, and calculating a probability distribution of the nodes whose subordinate connections are all in series with same methods as in a Step C) and a Step D);

wherein in the Step B), the nodes whose subordinate connections are all in series are regarded as one component, and then the probability distribution of the parent node can be obtained with the method as in the Step A);

C) for the series subsystem formed by connecting the multiple components to the same parent node in series as shown in FIG. 1, calculating with the UGF to obtain the probability distribution of the parent node; and

D) for the series subsystem formed by connecting the multiple components and the multiple nodes whose subordinate connections are all in parallel to the same parent node in series as the child nodes as shown in FIG. 3, judging and discretizing a probability distribution of the nodes whose subordinate connections are all in parallel, in such a manner that all the child nodes subordinate to the parent node are discretized, and then calculating with the UGF to obtain the probability distribution of the parent node, and calculating the probability distribution of the nodes whose subordinate connections are all in parallel with same methods as in the Step A) and Step B);

wherein in the Step D), the nodes whose subordinate connections are all in parallel are regarded as one component, and then the probability distribution of the parent node can be obtained with the method as in the Step C).

The multi-state series-parallel system represented by the tree structure can be subdivided into combinations of the above four categories. Therefore, according to the four categories, the probability distribution of the parent node of each level of a complete tree structure is calculated in turn from end leaf nodes; finally, probability distribution of a root parent node of the whole multi-state series-parallel system is obtained, thereby obtaining the reliability of the multi-state series-parallel system.

In the present invention, any multi-state series-parallel system is converted into the tree structure, and series or parallel layers of the tree structure have the structures as shown in FIG. 3 or FIG. 4, namely any parent node p having parallel subordinate connections only has child nodes S whose subordinate connections are in series and child nodes E representing components; and, any parent node S having series subordinate connections only has child nodes S whose subordinate connections are in parallel and child nodes E representing components. System structure tree representation can briefly and clearly reflect structural information of the series-parallel system, and can divide the series-parallel system into different levels of the series subsystems and the parallel subsystems.

Before implementation, the method of the present invention converts the multi-state series-parallel system into the tree structure, which is divided into different levels of the series subsystems and the parallel subsystems.

In the tree structure, each of the end leaf nodes records probability distribution information of one component, a leaf node corresponds to a component, and nodes at an end of the tree structure are all leaf nodes; the parent node of the parent and child nodes records subordinate connections between the parent node and all the subordinate child nodes.

The leaf nodes represented by the components and all other nodes have multiple states with their own probability. In an initial state, the probability distribution of the component is known, and the probability distribution of other nodes other than the leaf nodes of the component is unknown, which needs to be calculated by the method of the present invention. Types and quantities of the states of different components or nodes may be different, resulting in different probability distribution of the various nodes.

There is only one way to connect the parent node to all child nodes thereof: in series or in parallel. Referring to FIG. 2, if the parent node is P, it means that the parent node is connected in parallel with all the child nodes. Referring to FIG. 1, if the parent node is S, it means that the parent node is connected in series with all the child nodes.

The components refer to working elements in the multi-state system, such as: a thermal power generator, a wind power generator, a photovoltaic solar panel, etc. in a power generation system; and a transmission belt, a pipeline, a power transmission line, etc. in a transmission system; and various devices in a mechanical system.

For the parallel subsystem formed only by connecting the multiple components to the same parent node in parallel as the child nodes (which means the parent node has parallel subordinate connections), the Step A) specifically comprises steps of:

firstly, obtaining the continuization value of the parent node of the parallel subsystem with a following formula:

Q=Πᵢ₌₁ⁿ|Eᵢ|

wherein Q represent the continuization value, |Eᵢ| represents a quantity of states for each of the components, i is a component number, n is a total quantity of the components;

then, comparing the continuization value Q obtained with a pre-determined continuization threshold Q₀;

if Q<Q₀, namely a current calculation complexity is low, calculating with the UGF to obtain the probability distribution of the parent node; and

if Q≥Q₀, namely a current calculation complexity is high, calculating with the Gaussian approximation to obtain the probability distribution of the parent node.

For the parallel subsystem formed only by connecting the multiple components to the same parent node in parallel as the child nodes (which means the parent node has parallel subordinate connections), the Step A) specifically comprises steps of:

firstly, obtaining the continuization value of the parent node of the parallel subsystem with a following formula:

Q=Πᵢ₌₁ⁿ|Eᵢ|×Πⱼ₌₁^{m}|Sⱼ|

wherein |Eᵢ| is a quantity of states for an i-th component node, i is a component number, n is a total quantity of the components; |Sⱼ| is a quantity of states for a j-th node whose subordinate connections are all in series (if there are other child nodes under the node, all states are combined, and same states are overlapped and merged into one state to calculate), j is a node number of the nodes whose subordinate connections are all in series, m is a total quantity of the nodes whose subordinate connections are all in series;

then, comparing the continuization value Q obtained with a pre-determined continuization threshold Q₀;

if Q<Q₀, namely a current calculation complexity is low, calculating with the UGF to obtain the probability distribution of the parent node; and

if Q≥Q₀, namely a current calculation complexity is high, calculating with the Gaussian approximation to obtain the probability distribution of the parent node.

In the present invention, it is considered that all components satisfy: the components are independent; the probability distribution of the components is discretized; and the state of the components is within a limited range.

Calculating with the Gaussian approximation to obtain the probability distribution of the parent node specifically comprises steps of:

calculating an expected value and a variance value of the parent node with a following formula, and forming Gaussian distribution of the parent node with the expected value and the variance value of the parent node, which is used as the probability distribution of the parent node:

μ=Σᵢ₌₁ⁿw̅ᵢ, σ²=Σᵢ₌₁ⁿsᵢ²

wherein μ is the expected value of the parent node, w̅ᵢ is an expected value of performance of an i-th child node of the parent node, σ² is the variance value of the parent node, sᵢ² is a variance value of the i-th child node subordinate to the parent node, i is a child node number subordinate to the parent node, n is a total quantity of the child nodes subordinate to the parent node.

The expected value of the performance w̅ᵢ is an average of multiplying all states under the child node by their own state probability values and then adding the results; the variance value sᵢ² is a variance obtained by calculating all states under the child node and their own state probability values.

For the series subsystem formed by connecting the multiple components and the multiple nodes whose subordinate connections are all in parallel to the same parent node in series as the child nodes, the Step D) specifically comprises steps of:

judging:

if probability distribution of the child nodes is discretized, skipping discretizing; and

if the probability distribution of the child nodes is not discretized, discretizing as follows:

dividing the probability distribution of the child nodes within an interval of [α−3·β,α+3·β] into D subintervals, wherein α is an expected value of the probability distribution of the child nodes, β is a standard deviation of the probability distribution of the child nodes; selecting states of endpoints between the subintervals and external endpoints of two end subintervals to obtain D+1 discretizing states, then using a following formula for probability normalization, so as to obtain final probability distribution:

$${w}_{k} = α - 3 \cdot β + k \times 6 β \text{/} D$$

$${p}_{k} = \frac{f ( {w}_{k} )}{{\sum }_{l = 0}^{D} f ( {w}_{l} )} , k ∈ \{ 0 , 1 , … , D \}$$

wherein f(⋅) is a probability density function of Gaussian distribution of the child nodes, wₖ and pₖ are respectively a k-th discretizing state and probability of the discretizing state after probability normalization.

In the Step B), calculating the probability distribution of the nodes whose subordinate connections are all in series with the same methods as in the Step C) and the Step D) specifically comprises steps of: using the method as in the Step C) to obtain the probability distribution of the nodes (as shown in FIG. 1), wherein the nodes only have components and the subordinate connections of the nodes are all in series; using the method as in the Step D) to obtain the probability distribution of the nodes (as shown in FIG. 3), wherein the nodes have components and multiple child nodes whose subordinate connections are all in parallel, and the subordinate connections of the nodes are all in series.

In the step D), calculating the probability distribution of the nodes whose subordinate connections are all in parallel with the same methods as in the Step A) and Step B) specifically comprises steps of: using the method as in the Step A) to obtain the probability distribution of the nodes (as shown in FIG. 2), wherein the nodes only have components and the subordinate connections of the nodes are all in parallel; using the method as in the Step B) to obtain the probability distribution of the nodes (as shown in FIG. 3), wherein the nodes have components and multiple child nodes whose subordinate connections are all in series, and the subordinate connections of the nodes are all in parallel.

### Beneficial Effects of the Present Invention

The present invention takes a large-scale multi-state series-parallel system as an analysis object, and provides continuization discretization approximation to approximate the system reliability.

The present invention adjusts a calculation process with the pre-determined continuization threshold and the discretizing values, which realizes approximate evaluation of the reliability of the large-scale multi-state series-parallel system, and realizes a balance between calculation accuracy and calculation efficiency, so as to improve computational complexity from exponential complexity of originally accurate calculation to a quadratic term, thereby greatly improving a calculation speed.

Therefore, the present invention has high calculation efficiency, small result error, flexible calculation, and wide application range. The present invention provides an effective technical approach for fast calculation of reliability analysis of large-scale power systems.

### BRIEF DESCRIPTION OF THE DRAWINGS

FIG. 1 illustrates a first typical structure of a multi-state series-parallel system of the present invention.

FIG. 2 illustrates a second typical structure of the multi-state series-parallel system of the present invention.

FIG. 3 illustrates a third typical structure of the multi-state series-parallel system of the present invention.

FIG. 4 illustrates a fourth typical structure of the multi-state series-parallel system of the present invention.

FIG. 5 illustrates a structure of the multi-state series-parallel system according to an embodiment of the present invention.

FIG. 6 illustrates a comparison of a reliability distribution function with a reliability accurate distribution, wherein the reliability distribution function is obtained by a continuous discrete method with D=11 according to the embodiment.

FIG. 7 illustrates a reliability distribution function obtained by the continuous discrete method with D=30 according to the embodiment.

### DETAILED DESCRIPTION OF THE PREFERRED EMBODIMENT

Referring to the drawings and an embodiment, the present invention will be further illustrated.

According to the embodiment, for a multi-state series-parallel system which is converted to a tree structure, a connection structure between a parent node and all child nodes thereof is divided into four categories: first, a parallel subsystem formed only by connecting multiple components to the same parent node in parallel as the child nodes; second, a parallel subsystem formed by connecting multiple components and multiple nodes whose subordinate connections are all in series to the same parent node in parallel as the child nodes; third, a series subsystem formed by connecting multiple components to the same parent node in series, and fourth, a series subsystem formed by connecting multiple components and multiple nodes whose subordinate connections are all in parallel to the same parent node in series as the child nodes.

If subordinate connections of the parent node are in series, the subordinate connections of the child nodes subordinate to the parent node cannot be in series, because components subordinate to the child nodes whose subordinate connections are all in series may be equivalently regarded as subordinate components of a parent node whose subordinate connections are all in series. Similarly, if subordinate connections of the parent node are in parallel, the subordinate connections of the child nodes subordinate to the parent node cannot be in parallel, because components subordinate to the child nodes whose subordinate connections are all in parallel may be equivalently regarded as subordinate components of a parent node whose subordinate connections are all in parallel.

In the present invention, any multi-state series-parallel system is converted into the tree structure, and series or parallel layers of the tree structure have the structures as shown in FIG. 3 or FIG. 4, namely any parent node P having parallel subordinate connections only has child nodes S whose subordinate connections are in series and child nodes E representing components; and, any parent node S having series subordinate connections only has child nodes S whose subordinate connections are in parallel and child nodes E representing components. System structure tree representation can briefly and clearly reflect structural information of the series-parallel system, and can divide the series-parallel system into different levels of the series subsystems and the parallel subsystems.

For the four categories, the approximate evaluation method comprises steps as follows.

A) for the parallel subsystem formed only by connecting the multiple components to the same parent node in parallel as the child nodes as shown in FIG. 2, calculating and comparing a continuization value, and then calculating with Gaussian approximation or UGF (Universal Generating Function) to obtain a probability distribution of the parent node.

For the parallel subsystem formed only by connecting the multiple components to the same parent node in parallel as the child nodes (which means the parent node has parallel subordinate connections), the Step A) specifically comprises steps of: firstly, obtaining the continuization value of the parent node of the parallel subsystem with a following formula:

Q=Πᵢ₌₁ⁿ|Eᵢ|

wherein Q represent the continuization value, |Eᵢ| represents a quantity of states for each of the components, i is a component number, n is a total quantity of the components;

then, comparing the continuization value Q obtained with a pre-determined continuization threshold Q₀;

if Q<Q₀, namely a current calculation complexity is low, calculating with the UGF to obtain the probability distribution of the parent node; and

if Q≥Q₀, namely a current calculation complexity is high, calculating with the Gaussian approximation to obtain the probability distribution of the parent node.

For the parallel subsystem formed only by connecting the multiple components to the same parent node in parallel as the child nodes (which means the parent node has parallel subordinate connections), the Step A) specifically comprises steps of: firstly, obtaining the continuization value of the parent node of the parallel subsystem with a following formula:

Q=Πᵢ₌₁ⁿ|Eᵢ|×Πⱼ₌₁^{m}|Sⱼ|

wherein |Eᵢ| is a quantity of states for an i-th component node, i is a component number, n is a total quantity of the components; |Sⱼ| is a quantity of states for a j-th node whose subordinate connections are all in series (if there are other child nodes under the node, all states are combined, and same states are overlapped and merged into one state to calculate), j is a node number of the nodes whose subordinate connections are all in series, m is a total quantity of the nodes whose subordinate connections are all in series;

then, comparing the continuization value Q obtained with a pre-determined continuization threshold Q₀;

if Q<Q₀, namely a current calculation complexity is low, calculating with the UGF to obtain the probability distribution of the parent node; and

if Q≥Q₀, namely a current calculation complexity is high, calculating with the Gaussian approximation to obtain the probability distribution of the parent node.

Calculating with the Gaussian approximation to obtain the probability distribution of the parent node specifically comprises steps of:

calculating an expected value and a variance value of the parent node with a following formula, and forming Gaussian distribution of the parent node with the expected value and the variance value of the parent node, which is used as the probability distribution of the parent node:

μ=Σᵢ₌₁ⁿw̅ᵢ, σ²=Σᵢ₌₁ⁿsᵢ²

wherein μ is the expected value of the parent node, w̅ᵢ is an expected value of performance of an i-th child node of the parent node, σ² is the variance value of the parent node, sᵢ² is a variance value of the i-th child node subordinate to the parent node, i is a child node number subordinate to the parent node, n is a total quantity of the child nodes subordinate to the parent node.

The expected value of the performance w̅ᵢ is an average of multiplying all states under the child node by their own state probability values and then adding the results; the variance value sᵢ² is a variance obtained by calculating all states under the child node and their own state probability values.

B) for the parallel subsystem formed by connecting the multiple components and the multiple nodes whose subordinate connections are all in series to the same parent node in parallel as the child nodes as shown in FIG. 4, calculating and comparing the continuization value, and then calculating with the Gaussian approximation or the UGF to obtain the probability distribution of the parent node, and calculating a probability distribution of the nodes whose subordinate connections are all in series with same methods as in a Step C) and a Step D);

wherein in the Step B), the nodes whose subordinate connections are all in series are regarded as one component, and then the probability distribution of the parent node can be obtained with the method as in the Step A);

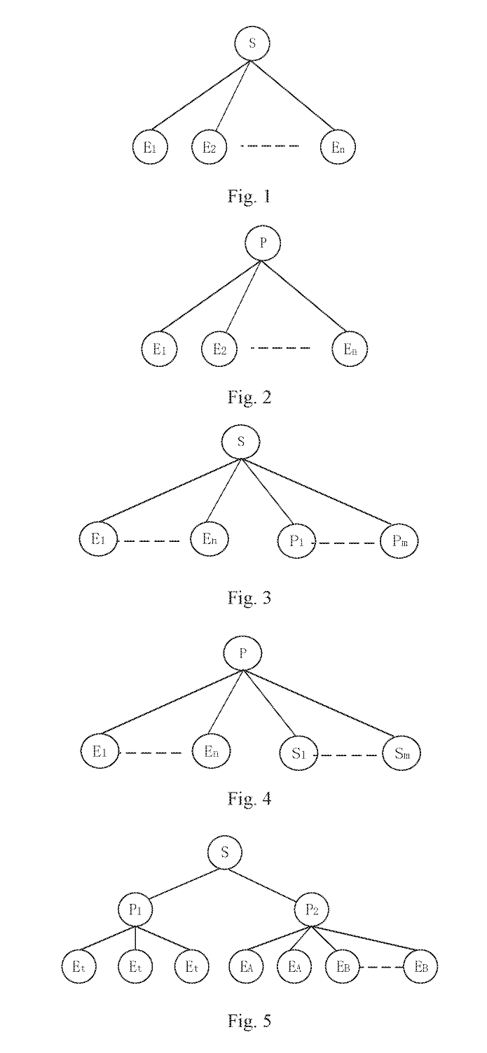

Calculating the probability distribution of the nodes whose subordinate connections are all in series with the same methods as in the Step C) and the Step D) specifically comprises steps of: using the method as in the Step C) to obtain the probability distribution of the nodes (as shown in FIG. 1), wherein the nodes only have components and the subordinate connections of the nodes are all in series; using the method as in the Step D) to obtain the probability distribution of the nodes (as shown in FIG. 3), wherein the nodes have components and multiple child nodes whose subordinate connections are all in parallel, and the subordinate connections of the nodes are all in series.

C) for the series subsystem formed by connecting the multiple components to the same parent node in series as shown in FIG. 1, calculating with the UGF to obtain the probability distribution of the parent node.

D) for the series subsystem formed by connecting the multiple components and the multiple nodes whose subordinate connections are all in parallel to the same parent node in series as the child nodes as shown in FIG. 3, judging and discretizing a probability distribution of the nodes whose subordinate connections are all in parallel, in such a manner that all the child nodes subordinate to the parent node are discretized, and then calculating with the UGF to obtain the probability distribution of the parent node, and calculating the probability distribution of the nodes whose subordinate connections are all in parallel with same methods as in the Step A) and Step B);

wherein in the Step D), the nodes whose subordinate connections are all in parallel are regarded as one component, and then the probability distribution of the parent node can be obtained with the method as in the Step C).

For the series subsystem formed by connecting the multiple components and the multiple nodes whose subordinate connections are all in parallel to the same parent node in series as the child nodes, the Step D) specifically comprises steps of:

judging:

if probability distribution of the child nodes is discretized, skipping discretizing; and

if the probability distribution of the child nodes is not discretized, discretizing as follows:

dividing the probability distribution of the child nodes within an interval of [α−3·β,α+3·β] into D subintervals, wherein α is an expected value of the probability distribution of the child nodes, β is a standard deviation of the probability distribution of the child nodes; selecting states of endpoints between the subintervals and external endpoints of two end subintervals to obtain D+1 discretizing states, then using a following formula for probability normalization, so as to obtain final probability distribution:

$${w}_{k} = α - 3 \cdot β + k \times 6 β \text{/} D$$

$${p}_{k} = \frac{f ( {w}_{k} )}{{\sum }_{l = 0}^{D} f ( {w}_{l} )} , k ∈ \{ 0 , 1 , … , D \}$$

wherein f(⋅) is a probability density function of Gaussian distribution of the child nodes, wₖ and pₖ are respectively a k-th discretizing state and probability of the discretizing state after probability normalization.

Calculating the probability distribution of the nodes whose subordinate connections are all in parallel with the same methods as in the Step A) and Step B) specifically comprises steps of: using the method as in the Step A) to obtain the probability distribution of the nodes (as shown in FIG. 2), wherein the nodes only have components and the subordinate connections of the nodes are all in parallel; using the method as in the Step B) to obtain the probability distribution of the nodes (as shown in FIG. 3), wherein the nodes have components and multiple child nodes whose subordinate connections are all in series, and the subordinate connections of the nodes are all in parallel.

The embodiment of the present invention:

The embodiment is a simplified power system, and a system structure tree of the system is as shown in FIG. 5. The power system is divided into two parts: a power generation system and a power transmission system. The power generation system consists of 7 units in parallel, which are 2 A-type units and 5 B-type units, wherein state distribution of each unit is shown in Table 1. The transmission system consists of three identical transmission lines. The transmission capacity of each transmission line during normal operation is 285 kW, and probability of failure is 0.03. The embodiment evaluates the reliability of the power system with the continuization discretization approximation and compares approximated results with accurate results. In calculation of the embodiment, the continuization threshold is Q₀=1000.

TABLE 1
state distribution of each unit of the power system

| | |
|---|---|
| A-type unit | B-type unit |

| output power | | output power | |
|---|---|---|---|
| (/kW) | probability | (/kW) | probability |
| 0 | 0.04 | 0 | 0.04 |
| 8.25 | 0.5664 | 2.85 | 0.3744 |
| 24 | 0.1248 | 36 | 0.4512 |
| 40.5 | 0.096 | 69 | 0.1152 |
| 56.25 | 0.0768 | 100.5 | 0.0135 |
| 72 | 0.096 | 133.5 | 0.0057 |

The reliability of the power system is calculated using the continuization discretization approximation proposed by the present invention. The system can be divided into a transmission subsystem P₁ and a power generation subsystem P₂. A continuization value of the transmission subsystem is less than the continuization threshold Q=2³<Q₀, and a continuization value of the power generation subsystem is greater than the continuization threshold Q=6⁷>Q₀. Therefore, the transmission subsystem uses the UGF method to calculate the accurate results, and the power generation subsystem uses the Gaussian approximation to calculate a Gaussian function. Then, probability state distribution obtained by discretizing the Gaussian function and probability state distribution of the transmission subsystem are calculated by the UGF method to obtain a serial result of the both, so as to obtain the reliability distribution of the power system.

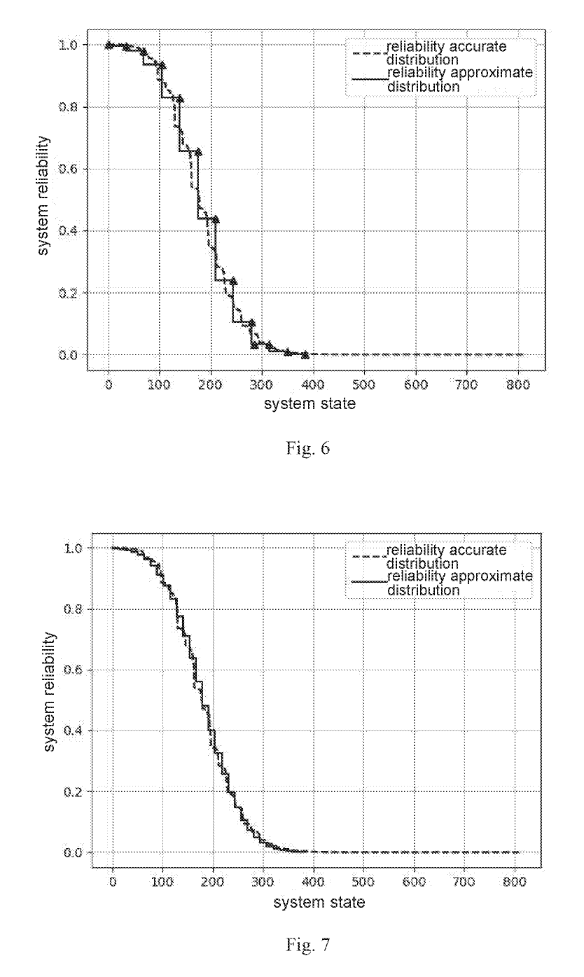

According to the embodiment, different discretizing values D have different effects. If the power system according to the embodiment adopts accurate calculation, 2261 different states are needed to represent a final reliability distribution result of the system. However, with the continuous discrete method of the present invention, much fewer states are required. FIG. 6 illustrates a comparison of a reliability distribution function with a reliability accurate distribution, wherein the reliability distribution function is obtained by a continuous discrete method with D=11. When D=1, only 13 states are needed to represent the system, and an average absolute error of reliability at these 13 states is 0.0212. FIG. 7 illustrates a reliability distribution function obtained by the continuous discrete method with D=30. At this time, the continuization discretization approximation uses 32 states to represent a final result, and an average absolute error of reliability at these 32 states is 0.0111. Comparing FIG. 6 with FIG. 7, it can be seen that increasing the parameter D can improve accuracy of the calculation results.

Therefore, the present invention can efficiently calculate the reliability of the power system, and the accuracy of the approximated result obtained is sufficient. The advantages of the present invention in terms of computational efficiency and computational accuracy will be more apparent when dealing with large scale systems. The computational complexity and computational accuracy can be adjusted by adjusting the pre-determined parameters Q₀ and D, wherein the parameters can be selected based on practical conditions such as actual scale of the system being processed and available computing resources.

Finally, it should be noted that the above embodiment is only used to illustrate the technical solutions and effects of the present invention, and are not intended to limit the scope thereof.

1-8. (canceled)

9: An approximate evaluation method for reliability of a large-scale multi-state series-parallel system, wherein:
for a multi-state series-parallel system which is converted to a tree structure, a connection structure between a parent node and all child nodes thereof is divided into four categories: first, a parallel subsystem formed only by connecting multiple components to the same parent node in parallel as the child nodes; second, a parallel subsystem formed by connecting multiple components and multiple nodes whose subordinate connections are all in series to the same parent node in parallel as the child nodes; third, a series subsystem formed by connecting multiple components to the same parent node in series, and fourth, a series subsystem formed by connecting multiple components and multiple nodes whose subordinate connections are all in parallel to the same parent node in series as the child nodes;
for the four categories, the approximate evaluation method comprises steps of:
A) for the parallel subsystem formed only by connecting the multiple components to the same parent node in parallel as the child nodes, calculating and comparing a continuization value, and then calculating with Gaussian approximation or UGF (Universal Generating Function) to obtain a probability distribution of the parent node;
B) for the parallel subsystem formed by connecting the multiple components and the multiple nodes whose subordinate connections are all in series to the same parent node in parallel as the child nodes, calculating and comparing the continuization value, and then calculating with the Gaussian approximation or the UGF to obtain the probability distribution of the parent node, and calculating a probability distribution of the nodes whose subordinate connections are all in series with same methods as in a Step C) and a Step D);
C) for the series subsystem formed by connecting the multiple components to the same parent node in series, calculating with the UGF to obtain the probability distribution of the parent node; and
D) for the series subsystem formed by connecting the multiple components and the multiple nodes whose subordinate connections are all in parallel to the same parent node in series as the child nodes, judging and discretizing a probability distribution of the nodes whose subordinate connections are all in parallel, in such a manner that all the child nodes subordinate to the parent node are discretized, and then calculating with the UGF to obtain the probability distribution of the parent node, and calculating the probability distribution of the nodes whose subordinate connections are all in parallel with same methods as in the Step A) and Step B);
wherein according to the four categories, the probability distribution of the parent node of each level of a complete tree structure is calculated in turn from end leaf nodes; finally, probability distribution of a root parent node of the whole multi-state series-parallel system is obtained, thereby obtaining the reliability of the multi-state series-parallel system.

10: The approximate evaluation method, as recited in claim 9, wherein in the tree structure, each of the end leaf nodes records probability distribution information of one component, and the parent node of the parent and child nodes records subordinate connections between the parent node and all the subordinate child nodes.

11: The approximate evaluation method, as recited in claim 9, wherein for the parallel subsystem formed only by connecting the multiple components to the same parent node in parallel as the child nodes, the Step A) specifically comprises steps of:
firstly, obtaining the continuization value of the parent node of the parallel subsystem with a following formula:
Q=Πᵢ₌₁ⁿ|Eᵢ|

wherein Q represent the continuization value, |Eᵢ| represents a quantity of states for each of the components, i is a component number, n is a total quantity of the components;
then, comparing the continuization value Q obtained with a pre-determined continuization threshold Q₀;
if Q<Q₀, calculating with the UGF to obtain the probability distribution of the parent node; and
if Q≥Q₀, calculating with the Gaussian approximation to obtain the probability distribution of the parent node.

12: The approximate evaluation method, as recited in claim 9, wherein for the parallel subsystem formed only by connecting the multiple components to the same parent node in parallel as the child nodes, the Step A) specifically comprises steps of:
firstly, obtaining the continuization value of the parent node of the parallel subsystem with a following formula:
Q=Πᵢ₌₁ⁿ|Eᵢ|×Πⱼ₌₁^{m}|Sⱼ|

wherein |Eᵢ| is a quantity of states for an i-th component node, i is a component number, n is a total quantity of the components; |Sⱼ| is a quantity of states for a j-th node whose subordinate connections are all in series, j is a node number of the nodes whose subordinate connections are all in series, m is a total quantity of the nodes whose subordinate connections are all in series;
then, comparing the continuization value Q obtained with a pre-determined continuization threshold Q₀;
if Q<Q₀, calculating with the UGF to obtain the probability distribution of the parent node; and
if Q≥Q₀, calculating with the Gaussian approximation to obtain the probability distribution of the parent node.

13: The approximate evaluation method, as recited in claim 11, wherein calculating with the Gaussian approximation to obtain the probability distribution of the parent node specifically comprises steps of: calculating an expected value and a variance value of the parent node with a following formula, and forming Gaussian distribution of the parent node with the expected value and the variance value of the parent node, which is used as the probability distribution of the parent node:
μ=Σᵢ₌₁ⁿw̅ᵢ, σ²=Σᵢ₌₁ⁿsᵢ²
wherein μ is the expected value of the parent node, w̅ᵢ is an expected value of performance of an i-th child node of the parent node, σ² is the variance value of the parent node, sᵢ² is a variance value of the i-th child node subordinate to the parent node, i is a child node number subordinate to the parent node, n is a total quantity of the child nodes subordinate to the parent node.

14: The approximate evaluation method, as recited in claim 12, wherein calculating with the Gaussian approximation to obtain the probability distribution of the parent node specifically comprises steps of: calculating an expected value and a variance value of the parent node with a following formula, and forming Gaussian distribution of the parent node with the expected value and the variance value of the parent node, which is used as the probability distribution of the parent node:
μ=Σᵢ₌₁ⁿw̅ᵢ, σ²=Σᵢ₌₁ⁿsᵢ²
wherein μ is the expected value of the parent node, w̅ᵢ is an expected value of performance of an i-th child node of the parent node, σ² is the variance value of the parent node, sᵢ² is a variance value of the i-th child node subordinate to the parent node, i is a child node number subordinate to the parent node, n is a total quantity of the child nodes subordinate to the parent node.

15: The approximate evaluation method, as recited in claim 9, wherein for the series subsystem formed by connecting the multiple components and the multiple nodes whose subordinate connections are all in parallel to the same parent node in series as the child nodes, the Step D) specifically comprises steps of:
judging:
if probability distribution of the child nodes is discretized, skipping discretizing; and
if the probability distribution of the child nodes is not discretized, discretizing as follows:
dividing the probability distribution of the child nodes within an interval of [α−3·β,α+3·β] into D subintervals, wherein α is an expected value of the probability distribution of the child nodes, β is a standard deviation of the probability distribution of the child nodes; selecting states of endpoints between the subintervals and external endpoints of two end subintervals to obtain D+1 discretizing states, then using a following formula for probability normalization, so as to obtain final probability distribution:
$${w}_{k} = α - 3 \cdot β + k \times 6 β \text{/} D$$
$${p}_{k} = \frac{f ( {w}_{k} )}{{\sum }_{l = 0}^{D} f ( {w}_{l} )} , k ∈ \{ 0 , 1 , … , D \}$$
wherein f(⋅) is a probability density function of Gaussian distribution of the child nodes, wₖ and pₖ are respectively a k-th discretizing state and probability of the discretizing state after probability normalization.

16: The approximate evaluation method, as recited in claim 9, wherein in the Step B), calculating the probability distribution of the nodes whose subordinate connections are all in series with the same methods as in the Step C) and the Step D) specifically comprises steps of: using the method as in the Step C) to obtain the probability distribution of the nodes, wherein the nodes only have components and the subordinate connections of the nodes are all in series; using the method as in the Step D) to obtain the probability distribution of the nodes, wherein the nodes have components and multiple child nodes whose subordinate connections are all in parallel, and the subordinate connections of the nodes are all in series.

17: The approximate evaluation method, as recited in claim 9, wherein in the step D), calculating the probability distribution of the nodes whose subordinate connections are all in parallel with the same methods as in the Step A) and Step B) specifically comprises steps of: using the method as in the Step A) to obtain the probability distribution of the nodes, wherein the nodes only have components and the subordinate connections of the nodes are all in parallel; using the method as in the Step B) to obtain the probability distribution of the nodes, wherein the nodes have components and multiple child nodes whose subordinate connections are all in series, and the subordinate connections of the nodes are all in parallel.
